(19) United States
(12) Patent Application Publication
(10) Pub. No.: US 2009/0119703 A1
(43) Pub. Date: May 7, 2009

(54) Mosaic of Alternate Programming During a Blackout

(75) Inventors: David Piepenbrink, Chicago, IL (US); Lee M. Chow, Naperville, IL (US)

Correspondence Address: AT&T Legal Department - JW;Attn: Patent Docketing, Room 2A-207, One AT&T Way, Bedminster, NJ, 07921, US

(73) Assignee: AT&T KNOWLEDGE VENTURES, L.P., Reno, NV (US)

(21) Appl. No.: 11/934,541

(22) Filed: Nov. 2, 2007

(51) Int. Cl. H04N 7/025

(52) U.S. Cl. 725/34

(57) ABSTRACT

In response to a user requesting content that has been blacked out, a mosaic is presented having images or data indicative of alternate programming. The mosaic may contain a plurality of viewports that each includes streaming video of currently available content. In conjunction with or in addition to the viewports, the mosaic may present metadata having statistics, cast information, program duration, time remaining, or other data associated with the alternate programming. In some embodiments, a set-top box employs a web-based template to present a mosaic that accesses multimedia content for display using at least one uniform resource locator.

### BACKGROUND

1. Field of the Disclosure

The present disclosure generally relates to providing multimedia content, and more specifically, to displaying viewports containing an alternate to blacked out multimedia content.

2. Description of the Related Art

In the field of broadcasting multimedia content such as television programs, particular programs may be restricted from distribution within certain markets. For example, if tickets to a sporting event do not “sell out” at a local stadium, local stations may be contractually forbidden from broadcasting the sporting event on television. In many cases, when a viewer changes the channel to attempt to select the blacked out content, the viewer is presented with a single screen that may have text indicating that the content has been blacked out.

### BRIEF DESCRIPTION OF THE DRAWINGS

FIG. 1 illustrates a representative Internet Protocol Television (IPTV) system for implementing disclosed embodiments;

FIG. 2 illustrates a graphical user interface for displaying a blackout mosaic that presents alternate programming to a viewer;

FIG. 3 illustrates a flow chart with blocks for displaying viewports containing alternate, available programming; and

FIG. 4 depicts a data processing system operable to execute instructions in accordance with disclosed embodiments.

### DESCRIPTION OF THE EMBODIMENT(S)

In one aspect, a method is disclosed for providing a mosaic of alternate programming. The method includes receiving a first request to transfer a first program that has been blacked out. The method includes automatically displaying the mosaic in response to the first request. The mosaic includes a plurality of viewports. At least a portion of the plurality of viewports displays content indicative of alternate programming.

In another aspect, a computer program product is disclosed. The computer program product is for providing multimedia content and includes computer executable instructions stored on a computer readable medium. The instructions are operable for displaying a mosaic including a plurality of viewports. A portion of the plurality of viewports corresponds to alternate programming currently available on alternate channels. Displaying the mosaic is in response to receiving a request to view blacked out multimedia content.

In an additional aspect, a method of providing a service is disclosed. The service enables an alternate programming feature in response to a request for blacked out multimedia programming. The method includes provisioning an application server with the blackout mosaic application. The blackout mosaic application is operable to respond to a user requesting blacked out multimedia content. The blackout mosaic application responds to a user request by accessing a plurality of resource links. Each resource link is associated with an alternate program. The blackout mosaic application responds by generating a blackout mosaic object. The blackout mosaic object includes instructions that, when executed, generate a display stream comprising a blackout mosaic template including at least one viewport. A video image associated with one of the alternate programs plays in the at least one viewport. The blackout mosaic application responds by sending the blackout mosaic object to a set-top box.

In the following description, for the purposes of explanation, numerous specific details are set forth in order to provide a thorough understanding of the disclosed embodiments. A person of ordinary skill in the art should recognize that embodiments may be practiced without some of these specific details. In other instances, well-known structures and devices may be shown in block diagram form or omitted for clarity.

Television programs, movies, radio programming and other multimedia content may be distributed over telephone company networks, coaxial-based networks, satellite transmissions, WiFi transmission, WiMAX transmission, and the like. In some systems, for example traditional coaxial-based “cable” systems, a service provider may distribute through the same coaxial or fiber-optic cable a compound signal containing a number of television channels at different frequencies. In conjunction, a set-top box or a tuner within a television, radio, or recorder selects one or more channels from the compound signal to play or record. In contrast to such systems that simultaneously distribute every available channel at all times, Internet Protocol Television (IPTV) systems generally distribute content only in response to user requests. Such IPTV systems typically use Internet Protocol (IP) and other technologies found in computer networks. To provide IPTV, a user's telephone lines may be used in some combination with a residential gateway (RG), a digital subscriber line (DSL) modem, a set-top box (STB), a display, and other such equipment to receive and convert into usable form the multimedia content provided from a telephone company network, for example.

IPTV providers, satellite-based providers, digital cable providers, and others may distribute multimedia content using bidirectional (i.e., two-way) communication between a user's customer premises equipment (CPE) and the service provider's equipment. Bidirectional communication allows a service provider to offer advanced features, such as video-on-demand (VOD), pay-per-view, advanced programming information, text-based news, and the like.

Disclosed embodiments provide enhancements for fulfilling blackout requirements that may be contractually imposed upon a service provider by providers of multimedia content. For example, service providers are often required to support blackouts from content providers that supply sporting events. In some cases, a static JPEG file is presented to a customer when the customer attempts to tune into a blacked out program. In some embodiments, when a user attempts to tune into blacked out programming, the user is presented with a mosaic style interface which may be accompanied by a textual message that the original content has been blacked out. The interface may include a plurality of viewports with live feeds of alternate multimedia content that is currently available on other channels. In some embodiments, one or more viewports in the mosaic may be empty, or they may have text-based information regarding the cast, duration time, titles, rating, or other parameter associated with the currently available alternate content. Viewports within the mosaic interface may be selectable to provide the user an opportunity to select for viewing the alternate content associated with the viewport. In some cases, the viewports may contain a still image captured from the currently available, alternate programming.

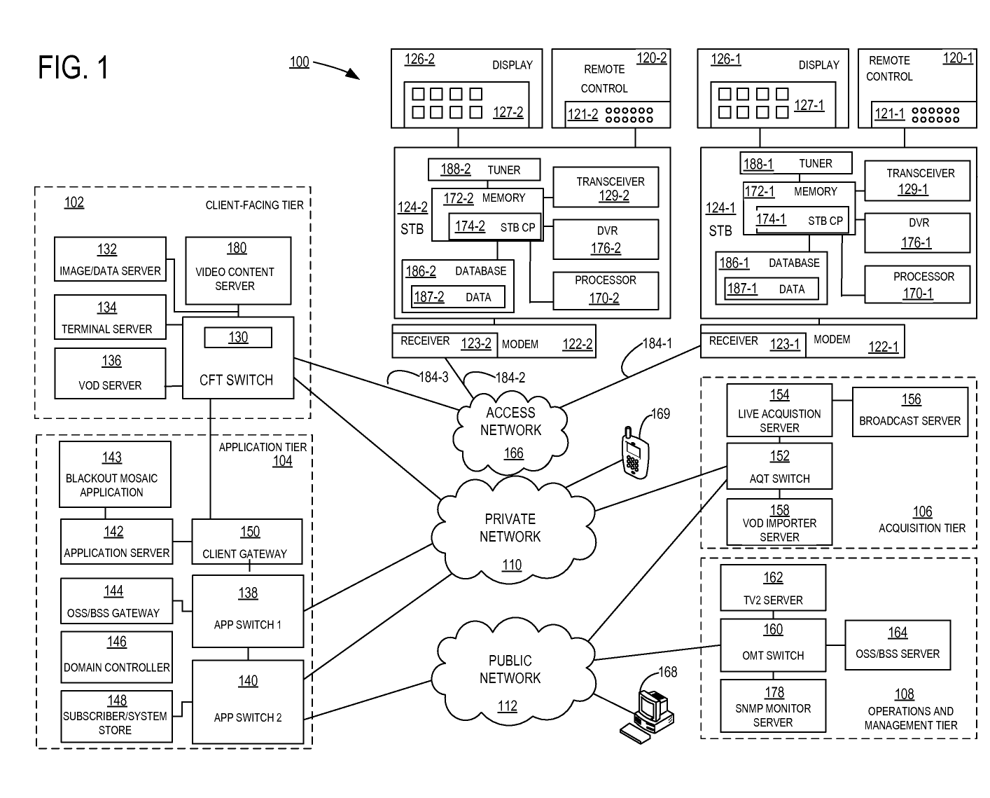

Referring now to the drawings, FIG. 1 illustrates selected aspects of an embodied IPTV system 100 operated as part of a service provider network. Throughout this disclosure, a hyphenated form of a reference numeral refers to a specific instance of an element and the un-hyphenated form of the reference numeral refers to the element generically or collectively. Thus, for example, reference numeral 124-1 refers to an instance of an element 124. As shown in FIG. 1, IPTV system 100 includes two set-top boxes (STBs) 124 including STB 124-1 and STB 124-2. In the depicted embodiment, STBs 124 communicate through access network 166 via modems 122 (i.e., modem 122-1 and modem 122-2).

As shown, IPTV system 100 is configured to provide multimedia content to users of STBs 124 and includes a client facing tier 102, an application tier 104, an acquisition tier 106, and an operations and management tier 108. Each tier 102, 104, 106 and 108 is coupled to a private network 110, to a public network 112 (e.g., the Internet), or to both the private network 110 and the public network 112. Any of the various tiers coupled to the various networks may communicate with each other over the networks. For example, as shown, the client-facing tier 102 may communicate through the private network 110 with the acquisition tier 106. Further, as shown, the application tier 104 may communicate through the private network 110 and the public network 112 with the acquisition tier 106. The interconnections between illustrated tiers and networks in FIG. 1 are meant as instructive and not limiting.

As shown, IPTV system 100 distributes multimedia content to users of STBs 124 for viewing on displays 126 and possibly for sending to other components not shown, such as stereo equipment. In order to distribute the multimedia content, IPTV system 100 must first gain access to the multimedia content. To that end, acquisition tier 106 represents a variety of systems to acquire multimedia content, reformat it when necessary, and prepare it for transmission over private network 110 or public network 112. In its capacity at acquiring and distributing multimedia for use on IPTV system 100, acquisition tier 106 serves as a “content headend.” Acquisition tier 106 may include, for example, systems for capturing analog and/or digital content feeds, either directly from a content provider or from a content aggregation facility. Content feeds transmitted via VHF/UHF broadcast signals may be captured by broadcast server 156. Similarly, live acquisition server 154 may capture satellite signals, high-speed fiber feeds, or programming feeds sent over other suitable transmission means. Content feeds to live acquisition server 154 may include broadcasted multimedia content, for example premium audio/video programming (i.e., traditional “cable channels”) widely available but not typically broadcast over airwaves. Acquisition tier 106 may further include signal conditioning systems and content preparation systems for encoding content. As shown, acquisition tier 106 includes video on demand (VoD) importer server 158 and may include a digital rights management (DRM) server for encrypting content (not shown). VOD importer server 158 receives content from one or more VOD sources that may be outside the IPTV system 100, for example discs or transmitted feeds. VOD importer server 158 may temporarily store multimedia content for transmission to a VOD server 136 on client-facing tier 102. In addition, the VOD content may be stored at one or more servers, such as the VOD server 136. The stored VOD content may be distributed by multicast (i.e., a single stream sent simultaneously to multiple viewers) or by unicast to individual users in a VOD system.

After acquiring the multimedia content, IPTV system 100 distributes the content over private network 110, for example. Private network 110 may be referred to as a “core network.” In some embodiments, private network 110 consists of a fiber backbone (i.e. WAN) and one or more video hub offices (VHOs). Generally, private network 110 transports multimedia content (e.g. video, music, Web pages, channel lineups, and data) from the acquisition tier 106 to STBs 124 through access network 166 (via client-facing tier (CFT) switch 130). In this role, private network 110 serves as the “backbone” for IPTV system 100. In a large deployment of IPTV system 100 that covers a vast geographic region, private network 110 may represent several smaller networks that each may only transfer content within a subset of the region. Accordingly, private network 110 may provide for the insertion of local content that is relevant only to a subset region. For example, private network 110 may allow for the localized insertion of local advertisements or local emergency alert systems for a particular service area.

To illustrate the distribution of multimedia content acquired by acquisition tier 106, in an example embodiment, broadcast server 156 acquires broadcast multimedia content and communicates it to live acquisition server 154. Live acquisition server 154 transmits the multimedia content to the AQT (AcQuisition Tier) switch 152. In turn, the AQT switch 152 transmits the multimedia content to the CFT switch 130, for example, via the private network 110. As shown, the CFT switch 130 may communicate the multimedia content through modems 122 via the private access network 166. In some embodiments, STBs 124 receive the multimedia content via modems 122 and transmit it to displays 126.

In some embodiments, live acquisition server 154 and VOD importer server 158 take numerous data streams and encode them into a digital video format, such as MPEG-2, or MPEG-4. After encoding, data streams may be encapsulated into IP data streams and transmitted to specific IP destinations (e.g. STBs 124) in response to a user's request for a particular channel, for example. Video content server 180, VOD server 136, or image/data server 132 may act as an intermediary or repository for multimedia content obtained and encoded by acquisition tier 106. In some embodiments, multimedia content is transmitted to the video content server 180, where it is encoded, formatted, stored, or otherwise manipulated and prepared for communication to the set-top box 124.

As shown, IPTV system 100 includes access network 166. Access network 166 provides a network link from the private network 110 to each consumer's location. To this end, access network 166 provides a network translation as necessary from a switched network, for example, to the access technology used to transmit data and multimedia content to the consumer's location. For example, a service provider that uses twisted-pair telephone lines to deliver multimedia content to consumers may utilize digital subscriber lines within access network 166. The digital subscriber lines may utilize some combination of DSL, DSL2, DSL2+, ADSL, VDSL or other technologies. In some embodiments, access network 166 may use fiber-to-the-home (FTTH). In such cases, optical fiber may be used all the way to the consumer's location to easily provide high-bandwidth. In other embodiments, fiber-to-the-curb (FTTC) deployments are used to deliver multimedia content to consumers. In such cases, a digital subscriber line access multiplexer (DSLAM) may be used within access network 166 to transfer signals containing multimedia content from optical fiber to copper wire for DSL delivery to consumers. In other embodiments, access network 166 may use RF signals sent over coaxial cables. Accordingly, access network 166 may utilize quadrature amplitude modulation (QAM) equipment for downstream traffic. In these systems, access network 166 may receive upstream traffic from a consumer's location using quadrature phase shift keying (QPSK) modulated RF signals. In such systems, a cable modem termination system (CMTS) may be used to mediate between IP-based traffic on private network 110 and access network 166.

In operation, if a user requests VOD content via an STB 124, the request may be transmitted over the access network 166 to VOD server 136, via the CFT switch 130. Upon receiving the request, the VOD server 136 retrieves or accesses the requested VOD content and transmits the content to the STB 124 across access network 166 via CFT switch 130. In turn, STB 124 transmits relevant video portions of the VOD content to the display 126. STB 124 may transmit audio portions of the VOD content to a stereo system (not shown) or may allow (or disallow) sending the VOD content to a recording device (not shown).

As shown, IPTV system 100 includes application tier 104. Application tier 104 communicates with acquisition tier 106 and client-facing tier 102 through private network 110. Application tier 104 may communicate through various communication protocols including hypertext transfer protocol (HTTP). Generally, application tier 104 may include notification servers, billing servers, and any of a variety of subscriber application servers employed by an owner or operator (i.e. network service provider) of IPTV system 100. In some embodiments, elements of the application tier 104 such as client gateway 150 communicate directly with the client-facing tier 102. The components of client-facing tier 102 may communicate using HTTP, transmission control protocol (TCP) or datagram protocol (UDP), as examples.

As illustrated in FIG. 1, the client-facing tier 102 is coupled for communication with user equipment (e.g. modems 122) via access network 166. Access network 166 may be referred to as the “last mile” for a service provider or network operator. It provides network connectivity of IPTV services to consumers' locations. Client-facing tier 102 may be required to multicast multimedia content to multiple destinations. For example, the same multimedia content may be distributed substantially simultaneously to STB 124-1 and STB 124-2. In contrast to a multicast or a unicast, some embodiments “broadcast” programming or data to all users on a network as a “broadcast” transmission. For example, a TV guide feature for displaying available programming may be broadcast to every user.

To deliver multimedia content, client-facing tier 102 may employ any current or future Internet protocols for providing reliable real-time streaming multimedia content. In addition to the TCP, UDP, and HTTP protocols discussed above, such protocols may use, in various combinations, other protocols including, file transfer protocol (FTP), real-time transport protocol (RTP), real-time control protocol (RTCP), and real-time streaming protocol (RTSP), as examples. In some embodiments, client-facing tier 102 sends multimedia content encapsulated into IP packets over access network 166. For example, an MPEG-2 transport stream may be sent, in which the transport stream consists of a series of 188-byte transport packets, for example. To ensure quality of service, protocols should be chosen that minimize dropped packets, jitter, delay, data corruption, and other errors.

As shown, modems 122 include a receiver 123 for receiving data 184-1 and 184-2. As shown, the client-facing tier 102 may communicate with a large number of set-top boxes, such as representative STBs 124, over a wide area, which may be for example, a regional area, a metropolitan area, a viewing area, a designated market area, or any other suitable geographic area, market area, or user group supported by networking the client-facing tier 102 to numerous set-top boxes. In an illustrative embodiment, the client-facing tier 102, or any portion thereof, may be included at a video headend office (not depicted).

In some embodiments, the client-facing tier 102 may be coupled to modems 122 via fiber optic cables. Alternatively, modems 122 may be DSL modems coupled to one or more network nodes via twisted pairs. Each set-top box 124 may process data received over the private access network 166 via various IPTV software platforms that are commonly known.

In an illustrative embodiment, the client-facing tier 102 includes a CFT switch 130 that manages communication between the client-facing tier 102 and the private access network 166. CFT switch 130 also manages communication between the client-facing tier 102 and the private network 110 and is coupled to an image and data server 132 that may store streaming multimedia content and possibly still images associated with programs of various IPTV channels. Image and data server 132 stores data related to various channels, for example, types of data related to the channels and to programs or video content displayed via the channels. In an illustrative embodiment, image and data server 132 may be a cluster of servers, each of which may store streaming multimedia content, still images, channel and program-related data, or any combination thereof CFT switch 130 may also be coupled to terminal server 134 that provides terminal devices with a connection point to the private network 110. As shown, CFT switch 130 may also be coupled to VOD server 136 that stores or provides VOD content imported by the IPTV system 100. As shown, the client-facing tier 102 also includes video content server 180 that transmits video content requested by viewers to STBs 124. In some embodiments, video content server 180 includes one or more multicast servers.

As illustrated in FIG. 1, application tier 104 may communicate with numerous components through private network 110 and public network 112. As shown, application tier 104 includes a first application tier (APP) switch 138 and a second APP switch 140. The first APP switch 138 is coupled to the second APP switch 140 and a combination operation-systems-support (OSS) and billing-systems-support (BSS) gateway 144 (i.e., OSS/BSS gateway 144). In some embodiments, the OSS/BSS gateway 144 controls access to an OSS/BSS server 164 that stores operations and billing systems data.

As shown, application tier 104 includes application server 142. Application server 142 may be any data processing system with associated software that provides information services (i.e. applications) for clients or users. Application server 142 may be optimized to provide services including conferencing, voicemail, and unified messaging. In some embodiments, services include electronic programming guides (EPG), conditional access systems (CAS), digital rights management (DRM) servers, a navigation/middleware server, and IPTV portal, e-mail services, and remote diagnostics. As shown, application server 142 is associated with or communicates with blackout mosaic application 143. In some embodiments, application server 142 hosts a blackout mosaic template (i.e., a mosaic object) for arranging on display 126-1 the blackout mosaic associated with a blacked out program. Within the blackout mosaic are viewports that may contain streaming video or screenshots of currently available, alternate programming. In addition, the viewports may contain metadata that is associated with the alternate data. For example, each viewport may contain cast names, directors names, duration, ratings, review results, and the like associated with alternate programming. The template may contain “holes” that may have associated executable commands used in enabling video content server 180 to populate the blackout mosaic with streaming video content corresponding to currently available multimedia programming available on the alternate channels. In some embodiments, blackout mosaic application 143 processes a user's request for multimedia content to determine whether the multimedia content may be blacked out. In the event the multimedia content is required to be blacked out for the user's geographic region, blackout mosaic application 143 may trigger set-top box 124 to send a compound video/audio signal to display 126 that contains the blackout mosaic rather than the originally-requested multimedia content.

As shown in FIG. 1, second APP switch 140 is communicatively coupled to a domain controller 146 that provides web access, for example, to users via the public network 112. The second APP switch 140 is communicatively coupled to a user and system store 148 that includes account information, such as account information that is associated with users who access the system 100 via the private network 110 or the public network 112. Therefore, for example, a user may employ a personal computer 168 to receive IPTV account information via the public network 112. Similarly, a user may employ cellular telephone 169 or another similar multifunction device over private network 110 or public network 112 to receive information through second APP switch 140. In some embodiments, application tier 104 may also include a client gateway 150 that communicates data directly with the client-facing tier 102. In these embodiments, the client gateway 150 may be coupled directly to the CFT switch 130. Accordingly, the client gateway 150 may provide user access to the private network 110 and the tiers coupled thereto.

In some embodiments, STB 124 accesses the IPTV system 100 via the private access network 166, using information received from the client gateway 150. In such embodiments, private access network 166 may provide security for the private network 110. Therefore, user devices may access the client gateway 150 via the private access network 166, and the client gateway 150 may allow such devices to access the private network 110 once the devices are authenticated or verified. Similarly, the client gateway 150 may prevent unauthorized devices, such as hacker computers or stolen set-top boxes, from accessing the private network 110, by denying access to these devices beyond the private access network 166.

Accordingly, in some embodiments, when an STB 124 accesses the IPTV system 100 via the private access network 166, the client gateway 150 verifies user information by communicating with the subscriber/system store 148 via the private network 110, the first APP switch 138, and the second APP switch 140. The client gateway 150 verifies billing information and user status by communicating with the OSS/BSS gateway 144 via the private network 110 and the first APP switch 138. The OSS/BSS gateway 144 may transmit a query across the first APP switch 138, to the second APP switch 140, and the second APP switch 140 may communicate the query across the public network 112 to the OSS/BSS server 164. Upon the client gateway 150 confirming user and/or billing information, the client gateway 150 allows the STB 124 access to IPTV content, VOD content, and other services. If the client gateway 150 cannot verify user information for the STB 124, for example, because it is connected to an unauthorized twisted pair or residential gateway, the client gateway 150 may block transmissions to and from the STB 124 beyond the private access network 166.

STBs 124 convert digital compressed signals into a format suitable for display. STBs 124 have functionality for recognizing and acting on IP packets, for example UDPs transmitted within IP datagrams. STBs 124 may contain software or firmware coding for sending requests to application server 142, for example, to receive requested programming or data. In some embodiments, requests for content (e.g. VOD content) flow through a billing or management server to verify that a user is not in arrears regarding payment. In some embodiments, STB 124 supports Web browsing on the Internet (e.g., public network 112) and may support cycling through guide data, for example, using Web services. Each STB 124 may be enabled for viewing e-mail, viewing e-mail attachments, and interfacing with various types of home networks.

In accordance with disclosed embodiments, each STB 124 may be a cable box, a satellite box, or an electronic programming guide box. Further, although shown separately, STBs 124 may be incorporated into any multifunctional device such as, a television, a videocassette recorder, a digital video recorder, a computer, a personal computer media player, or other media device. Generally, STBs 124 each represent a dedicated data processing system (e.g., computer) that provides an interface between a display and a service provider. As shown, STBs 124 are connected to the service provider through modems 122. Although modems are shown in FIG. 1, other residential gateways may be employed. Alternatively, STBs 124 may be connected directly to access network 166.

STBs 124 contain software or firmware instructions stored in memories 172 or other storage for receiving and processing input from remote controls 120. In some embodiments, STBs 124 are IP based set-top boxes and have capability for outputting resultant multimedia signals (e.g., streaming audio/video) in various formats including S-video, composite video, high definition component video, high definition multimedia interface (HTMI), and video graphics array (VGA) signals. The resultant multimedia signals may support displays 126 that have various video modes including analog NTSC, 1080i, 1080p, 480i, 480p, 720p, as examples. In some embodiments, STBs 124 communicate with modems 122 over local area networks (LANs) connected using CAT5 cables, CAT6 cables, wireless interfaces, or a Home Phoneline Networking Alliance (HPNA) network, as examples.

As shown STBs 124 are coupled to displays 126. Each display 126 may include a cathode ray tube (CRT), television, monitor, projected image, LCD screen, holograph, or other graphical equipment. In accordance with disclosed embodiments, displays 126 display a blackout mosaic which includes streaming video of content currently available on channels alternate to a blacked out channel.

STBs 124 communicate with remote controls 120. In accordance with disclosed embodiments, remote controls 120 include selection buttons that a user may depress to request blacked out content to be displayed on display 126. In response to receiving the request for blacked out content, display 126 shows a blackout mosaic containing a plurality of viewports with currently available, alternate programming. Remote control 120 contains directional selection buttons or numerical selection buttons that may be used to navigate to a particular viewport associated with programming that the user desires to view instead of the blacked out programming. Remote control 120 may contain a selection button or enter button to select the particular viewport, which may be highlighted or otherwise emphasized on display 126. STBs 124 may include wireless transceivers 129 to communicate with wireless transceivers (not shown) of remote controls 120. Although the term “buttons” is used to describe some embodiments herein, other forms of input may be used. For example, touch screens associated with remote controls 120 may be used to accept user input. Alternatively, remote controls 120 may be used in conjunction with STBs 124 to operate graphical user interfaces (GUIs) displayed on displays 126.

STBs 124 as shown receive data 184, which may include video content and/or audio content or portions, from the client-facing tier 102 via the private access network 166. Data 184 may be associated with at least one program, such as a broadcast program, that includes streaming multimedia content. As it receives data 184, STB 124 may store the content or may format the content into a resultant multimedia signal for sending to displays 126 and other equipment (not shown) for producing portions of the multimedia content in usable form.

As shown, each STB 124 includes an STB processor 170 and an STB memory 172 that is accessible by STB processor 170. An STB computer program (STB CP) 174, as shown, is embedded within each STB memory 172. In accordance with disclosed embodiments, the STB CP 174 may include a client application for calling a blackout mosaic application associated with application server 142. As shown, memory 172 are coupled with databases 186 that each include data 187. Data 187 may include currently available, alternate channels or multimedia content associated with blacked out programming. In the alternative, data 187 may contain information regarding whether a particular requested program has been blacked out for the geographical region in which STB 124 is located.

In addition to or in conjunction with STB components illustrated in FIG. 1, STBs 124 may contain modules for transport, de-multiplexing, audio/video encoding and decoding, audio digital to analog converting, and radio frequency (RF) modulation. For clarity, such details for these modules are not shown in FIG. 1. In addition details are not provided for allowing STBs 124 to communicate through access network 166 through modems 122. However, such communications can be carried out with known protocols and systems for network interfacing such as conventional network interface cards (NICs) used in personal computer platforms. For example STB 124 may use a network interface that implements level 1 (physical) and level 2 (data link) layers of a standard communication protocol stack by enabling access to a twisted pair or other form of physical network medium and supporting low level addressing using media access control (MAC) addressing. In these embodiments, STBs 124 may each have a network interface including a globally unique 48-bit MAC address stored in a ROM or other persistent storage element. Similarly, each modem 122 (or other RG) may have a network interface (not depicted) with its own globally unique MAC address. Further, although STBs 124 are depicted with various functions in separate components, these components may be implemented with a system on chip (SoC) device that integrates two or more components.

As shown, STBs 124 may also include a video content storage module, such as a digital video recorder (DVR) 176. In a particular embodiment, STBs 124 may communicate commands received from the remote control devices 120 to the client-facing tier 102 via the private access network 166. Commands received from the remote control devices 120 may be entered via buttons 121. The commands received (i.e. user input) may include a selection of one of the viewports blackout mosaic 127 on the displays 126.

IPTV system 100 includes an operations and management tier 108 that has an operations and management tier (OMT) switch 160. OMT switch 160 conducts communication between the operations and management tier 108 and the public network 112. The OMT switch 160 is coupled to a TV2 server 162. Additionally, the OMT switch 160 as shown is coupled to an OSS/BSS server 164 and to a simple network management protocol (SNMP) monitor server 178 that monitors network devices within or coupled to the IPTV system 100. In some embodiments, the OMT switch 160 communicates with the AQT switch 152 via the public network 112.

In an illustrative embodiment, the live acquisition server 154 transmits the multimedia content to the AQT switch 152, and the AQT switch 152, in turn, transmits the multimedia content to the OMT switch 160 via the public network 112. In turn, the OMT switch 160 transmits the multimedia content to the TV2 server 162 for display to users accessing the user interface at the TV2 server 162. For example, a user may access the TV2 server 162 using a personal computer (PC) 168 coupled to the public network 112.

Embodiments disclosed herein use IPTV system 100 to provide a user with a blackout mosaic that includes streaming video currently available and selectable in place of the blacked out content. A user of remote control 120 provides user input through one or more buttons 121 to attempt selecting blacked out content for viewing on display 126. In response, STB 124 calls for viewing the blacked out content, and blackout mosaic application 143, which may be hosted on application server 142, determines whether the STB 124 is located in a region in which the content should be blacked out. If the STB 124 is located in a region that is required to black out the requested multimedia content, blackout mosaic application 143 may host a frame or template which contains URL calls to alternate, currently available channels. In some embodiments, blackout mosaic application 143 hosts a frame (i.e., template) with URL calls (e.g. executable instructions) for populating a blackout mosaic on display 126. In some embodiments, video content server 180 populates the frame using the URL calls or executable instructions to provide a streaming content over access network 166 to STB 124. In such cases, the URLs are part of instructions to retrieve at least one multimedia content stream for each currently available, alternate channel having an associated viewport in a blackout mosaic. STB 124 may receive or have stored instructions to generate a display stream made up of the mosaic template and viewports for each alternate channel. In some embodiments, the display stream includes a first viewport and a second viewport. A first multimedia content stream (substantially the same as and synchronized with content currently available on the corresponding alternate channel) plays within the first viewport and a second multimedia content stream (substantially the same as and synchronized with content currently available on the corresponding alternate channel) plays within the second viewport.

In accordance with disclosed embodiments, the displayed blackout mosaic contains a plurality of viewports or thumbnails that show streaming videos of whatever content is currently available and provided alternate to the blacked out channel. Such a system provides the user with an easy way of determining whether he or she may want to change the channel to a particular alternate channel. If the user determines by viewing the blackout mosaic that a particular channel is showing a commercial, for example, the user may decide to wait for the commercial to end before changing to that channel.

A plurality of video viewports or thumbnails included in a blackout mosaic are presented substantially in real time with corresponding broadcasts that correspond to alternate multimedia on alternate channels. In other words, the blackout mosaic is intended to display the streaming video content currently available on the alternate channels, so that a user may determine whether he or she wishes to switch to an alternate channel for full or partial display on a monitor (e.g. display 126). The plurality of video thumbnails may include a plurality of live broadcasts, pre-recorded broadcasts, or VOD content. The plurality of video thumbnails or viewports may include a plurality of reduced size video images, and may include viewports of different sizes and different resolutions. STBs 124 may include a plurality of tuners 188, for example, one tuner for each of the viewports in blackout mosaic 127 displayed simultaneously on display 126. Alternatively, a template hosted by blackout mosaic application 143 or accessed by STB 124 may be used to automatically make URL calls for populating the viewports without the need for individual tuners.

In some embodiments, the channels include broadcast channels sent over coaxial cables. The channels may also include broadband channels, for example high-speed, high-capacity data transmission channels that send and receive information on cable. The cable, which may be coaxial cable or fiber-optic cable, may have a wider bandwidth than conventional telephone lines, and may have the ability to carry video, voice, data, and other multimedia content simultaneously.

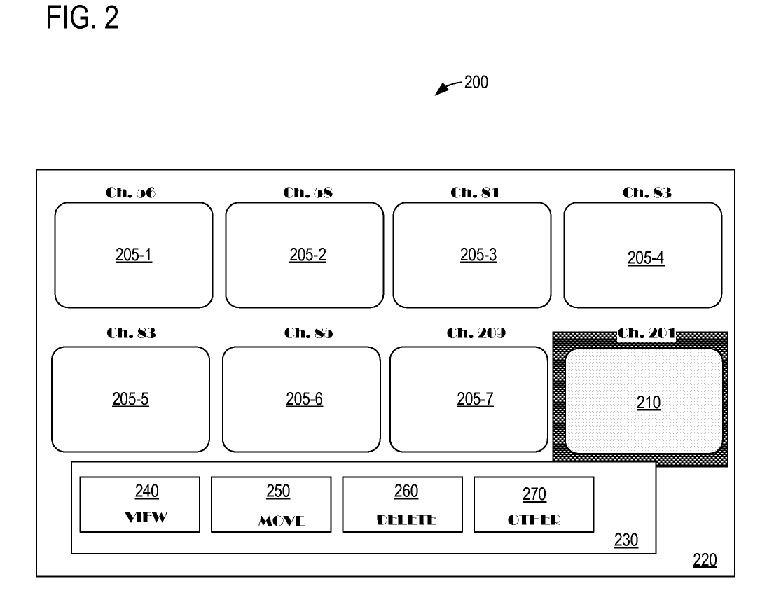

FIG. 2 illustrates a graphical user interface 200 that includes a plurality of streaming video thumbnails (i.e., viewports) 205. In addition to the streaming video thumbnails, meta-data associated with programming may also be presented (not shown). For example, cast information, a show's title, a show's remaining time, a show's duration, or other information may be presented with graphical user interface 200. The video thumbnails may be presented in sequential order of the most recently tuned-into broadcast channels, may be ordered according to how frequently they are viewed, or may be ordered according to a predetermined ranking stored by a user. The thumbnails 205 may be presented in a straight line, in an array (as shown), or in any other convenient presentation. In some embodiments, the number of thumbnails may correspond to the number of tuners 188 present in the STB 124 (FIG. 1). In other systems, such as IPTV systems, the graphical user interface 200 is determined by a template stored or hosted by application server 142 (FIG. 1).

In some embodiments, upon a user providing user input to buttons 121 (FIG. 1) on remote control 120 (FIG. 1), STB 124 calls to the blackout mosaic application 143 hosted on application server 142. This call to the blackout mosaic application 143 may result in one or more calls to other components of IPTV system 100, for example video content server 180. Upon being called, for example by executable instructions in a mosaic template hosted or accessed by blackout mosaic application 143, video content server 180 provides a streaming multimedia output for each viewport in the template. Accordingly, each viewport in a template is populated with streaming content that is currently available on channels alternate to the blacked out content. In some embodiments, STB 124 receives streaming multimedia content streams directly from video content server 180 over access network 166 without the content passing through the application server 142.

As shown in FIG. 2, thumbnail (i.e., viewport) 210 (i.e., channel 201) is highlighted with a darker background, in response to user input for selecting the viewport. This thumbnail may be selected using the navigation controls of the remote control 120 (i.e., input device), for example. As shown, the interface 200 includes a background 220, which may be a blank screen, a colored screen, or a streaming broadcast (not shown). If the background 220 is a streaming broadcast, it may or may not be the same channel as one of thumbnails 205 or 210. Interface 200, as part of a blackout mosaic, may also include a previous channel viewport, with streaming video corresponding to the channel that was displayed upon the user requesting the blacked out channel. The background broadcast (background 220) may be switchable to other channels using a channel up/down button on remote control 120. In accordance with disclosed embodiments, thumbnails of video broadcasts, each consisting of streaming video, may be presented on the interface 200 after selecting blacked out content using an input device to indicate a selection from several choices presented in thumbnail format.

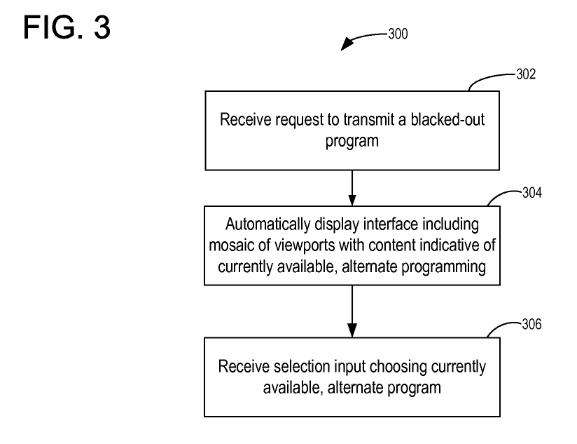

FIG. 3 illustrates a flow chart 300 for viewing a selection of thumbnails in accordance with some embodiments. Block 302 provides for receiving a request to transmit a blacked out program. For example, a user may select a sporting event that has been blacked out by the content provider. In some cases, a content provider may provide a signal to a service provider that particular content has been blacked out. For example, a content provider may include a code within the header of each datagram or packet upon encapsulation of the potentially blacked out content. The code may be used to determine whether the content is acceptable for viewing in a particular region. Block 304 provides functionality for automatically displaying an interface including a mosaic of viewports. The mosaic of viewports each has content indicative of currently available, alternate programming. Block 306 includes optional functionality for receiving a selection input from the user for choosing currently available, alternate programming. For example, the user may highlight one of the mosaic's viewports using directional controls on a remote control to highlight a particular viewport. By pressing an “enter” command or some similar command, the user may select the currently available, alternate program. The program may be a television program or sporting event, as examples. Flow chart 300 contains representative aspects of embodiments for providing a user with an interface containing a mosaic of viewports. Each viewport represents alternative programming that may be substituted for the blacked out programming.

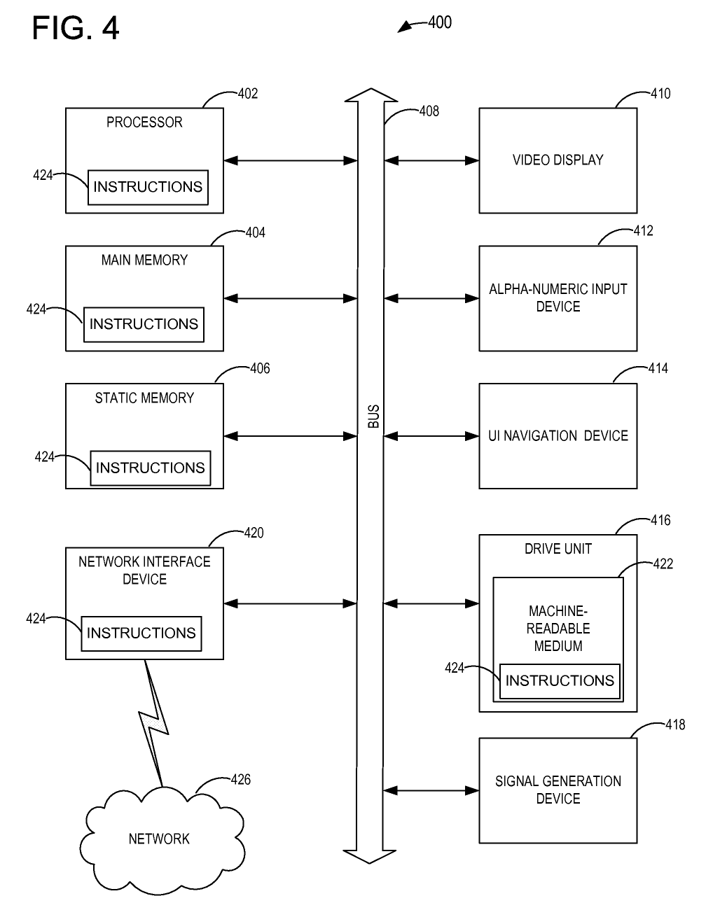

FIG. 4 is a diagrammatic representation of a machine in the example form of a computer system 400 within which a set of instructions for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a digital video recorder (DVR), a personal computer (PC), a tablet PC, a set-top box (STB), a cable box, a satellite box, an electronic programming guide box, a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 includes a processor 402 (e.g., a central processing unit (CPU), a graphics processing unit (GPU) or both), a main memory 404 and a static memory 406, which communicate with each other via a bus 408. The main memory 404 and/or the static memory 406 may be used to store the channel history data. The computer system 400 may further include a video display unit 410 (e.g., a television, a liquid crystal display (LCD) or a cathode ray tube (CRT)) on which to display broadcast or other programs, for example. The computer system 400 also includes an alphanumeric input device 412 (e.g., a keyboard or a remote control), a user interface (UI) navigation device 414 (e.g., a remote control, or a mouse), a disk drive unit 416, a signal generation device 418 (e.g., a speaker) and a network interface device 420. The input device 412 and/or the navigation device 414 (e.g., the remote control) may include a processor (not shown), and a memory (not shown). The disk drive unit 416 includes a machine-readable medium 422 on which is stored one or more sets of instructions and data structures (e.g., instructions 424) embodying or utilized by any one or more of the methodologies or functions described herein (e.g., the software to access the channel history data in the database 186). The instructions 424 may also reside, completely or at least partially, within the main memory 404 and/or within the processor 402 during execution thereof by the computer system 400.

The instructions 424 may further be transmitted or received over a network 426 (e.g., a television cable provider) via the network interface device 420 utilizing any one of a number of well-known transfer protocols (e.g., broadcast transmissions, HTTP). While the machine-readable medium 422 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals.

Although an embodiment of the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. A method of providing a mosaic of alternate programming, the method comprising:
receiving a first request to transmit a first program, wherein the first program has been blacked out;
in response to the first request, automatically displaying the mosaic, wherein the mosaic includes a plurality of viewports, wherein at least a portion of the plurality of viewports displays content indicative of alternate programming.

2. The method of claim 1, wherein the plurality of viewports is selectable from a graphical user interface.

3. The method of claim 1, further comprising:
receiving a second request to black out the first program.

4. The method of claim 1, wherein the content indicative of alternate programming includes a plurality of streaming videos associated with currently available content, wherein each of the plurality of streaming videos corresponds to one viewport.

5. The method of claim 1, wherein a mosaic template is employed in constructing the mosaic, wherein the mosaic template has a plurality of holes, wherein each hole corresponds to a corresponding viewport.

6. The method of claim 5, wherein each hole corresponds to a URL, wherein each URL corresponds to a source for an alternate program.

7. The method of claim 5, wherein the mosaic template is stored in a memory of a set-top box.

8. The method of claim 3, further comprising:
receiving a third request to transmit a second program, the second program corresponding to one of the plurality of viewports.

9. A computer program product comprising computer executable instructions, stored on a computer readable medium, for providing multimedia content, the instructions operable for:
displaying a mosaic including a plurality of viewports, wherein a portion of the plurality of viewports corresponds to alternate programming currently available on alternate channels, wherein displaying the mosaic is in response to receiving a request to view blacked out multimedia content.

10. The computer program product of claim 9, further comprising instructions operable for:
detecting that the blacked out multimedia content is blacked out.

11. The computer program product of claim 9, further comprising instructions operable for:
generating a mosaic object including:
instructions to retrieve a first multimedia content stream associated with a first channel and a second multimedia content stream associated with a second channel, wherein the first channel has a first alternate program, wherein the second channel has a second alternate program.

12. The computer program product of claim 11, further comprising instructions operable for:
generating a display stream comprising a mosaic template including a first viewport and a second viewport, wherein the first multimedia content stream plays within the first viewport and wherein the second multimedia content stream plays within the second viewport.

13. The computer program product of claim 12, further comprising instructions operable for delivering the mosaic object to a set-top box.

14. The computer program product of claim 11, wherein the instructions to retrieve the first multimedia content stream include instructions for transmitting a first IP address from an application server to a content server, wherein the first IP address is associated with the first multimedia content stream.

15. A method of providing a service enabling an alternate programming feature in response to a request for blacked out multimedia programming, the method comprising:
provisioning an application server with a blackout mosaic application wherein the blackout mosaic application is operable to respond to a user requesting blacked out multimedia content by:
accessing a plurality of resource links, wherein each resource link is associated with an alternate program;
generating a blackout mosaic object wherein the blackout mosaic object includes instructions, operable when executed, to generate a display stream comprising a blackout mosaic template including at least one viewport wherein a video image associated with one of the alternate program plays in the at least one viewport; and
sending the blackout mosaic object to a set-top box.

16. The method of claim 15, wherein the blackout mosaic template includes at least one additional viewport.

17. The method of claim 16, wherein an additional video image associated with an additional alternate program plays in the additional viewport.

18. The method of claim 15, wherein the video image is a streaming image of currently available video content.

19. The method of claim 15, wherein the blackout mosaic template is an HTML template.

20. The method of claim 19, wherein generating the blackout mosaic object includes accessing at least one resource locator associated with alternate programming.
